(19) United States
(12) Patent Application Publication
(10) Pub. No.: US 2003/0023550 A1
(43) Pub. Date: Jan. 30, 2003

(54) Method and system for billing on the internet

(76) Inventor: Sang Won Lee, Seoul (KR)

Correspondence Address: MARTINE & PENILLA, LLP, 710 LAKEWAY DRIVE, SUITE 170, SUNNYVALE, CA, 94085, US

(21) Appl. No.: 10/182,853

(22) PCT Filed: Feb. 10, 2001
(86) PCT No.: PCT/KR01/00198

(30) Foreign Application Priority Data
Feb. 10, 2000 (KR) 2000/6192

(51) Int. Cl. G06F 17/60

(52) U.S. Cl. 705/40

(57) ABSTRACT

The clients visiting through the internet subscribe to a billing center and select either an advance or a deferred payment. In case of an advance payment, an exchange ticket is purchased and is used for payment. The contents provider willing to adopt the billing system according to the present invention should join through the billing center, set up a billing client program and construct directories and service files according to a billing plan. The constructed directories and service files are registered as menus in the billing center. The service provided to a client in a contents provider's site through the internet is charged according to a menu registered in the billing center. The payment of a bill is performed through a financial agency which is connected to the billing center via a payment gateway.

### TECHNICAL FIELD

The present invention is about billing plans and systems for the billing through a wired or wireless internet connection. and especially on a meter rate or a flat rate plans and billing systems for downloading contents by wired or wireless internet connections or for reading web pages.

### BACKGROUND ART

According to the development of communications through the internet services providing music files, pictures, legal or medical services are getting popular. Especially, since the online service for personal computer users becomes popular, information service providing business is also promoted. The online service for personal computer users is provided under a closed environment and it is easy to check how much a client uses specified information, and to demand payment for it. Furthermore, the online service provider takes full charge of the examination of information used and billing, the information service provider can concentrate on the quality of information. It makes the online service a good ground for acquiring quality information.

On the other hand according to the popularity of the internet, information offering through the internet is also getting popular. However, unlike the online services the internet is an open communication system and has no restriction in users connected and therefore, the billing for the information provided is a complicated problem.

That is, the information provider has to monitor the information provided for a client and has to demand payment for the information, which is becoming a big burden. For this reason, the information service provider offers information based on either an advertising revenue or offers information for members who pays for a monthly membership fee.

In order to provide information and to run up profit in the internet the information service provider can construct and operate a contents billing system by itself. But, most of the information service providers are specialized in a specific field and planning for the business and have limits in constructing an independent billing system. In addition, they have difficulties in operating a specialized system as well as securing cost required for constructing the system.

Therefore, regarding the billing on the internet there have been continuous demands for a billing center which constructs and operates the billing system stably outside by system operators. Also, the easy and reasonable charging method according to the information used by a client has been demanded.

### DISCLOSURE OF INVENTION

The purpose of the present invention is to provide billing, plans and systems through a wired or wireless internet connection which make the billing for information used on the internet easy considering the aforementioned difficulties.

Another purpose of the present invention is to provide billing plans and systems through a wired or wireless internet connection selected from a time meter rate, a packet meter rate, a hit rate a session meter rate, a flat rate or a complex rate mixing a meter rate and a flat rate according to the characteristics of each site.

### BRIEF DESCRIPTION OF THE DRAWINGS

FIG. 1 is a schematic block diagram showing the construction of a billing system according to the present invention.

FIG. 2 is a schematic block diagram showing the internal structure of a billing center in a billing system according to the present invention.

FIG. 3 is a schematic block diagram showing the internal structure of a contents provider in a billing system according to the present invention.

FIG. 4 is a flow chart showing the procedures for a contents provider to apply for a subscription and to set up a billing plan and a service charge.

FIG. 5 through FIG. 8 are examples of screens which appear when a contents provider sets up a billing plan and a service charge.

FIG. 9 is a drawing showing the billing procedure when using contents.

FIG. 10 is a drawing showing the motion flow of a billing client in a hit rate and a packet meter rate.

FIG. 11 is a drawing showing the motion flow of a billing client in a session meter rate.

FIG. 12 is a drawing showing the motion flow of a billing client in a time meter rate.

### BEST MODE FOR CARRYING OUT THE INVENTION

The internet users subscribe to a billing center and select either an advance payment or a deferred payment. In case of an advance payment, an exchange ticket is purchased and is used for payment. The contents provider willing to adopt the billing system according to the present invention should join through a billing center, set up a billing client program and construct directories and service files according to a billing plan. The constructed directories and service files are registered as a menu in the billing center. The services provided to clients in a contents provider's site through the internet are charged according to a menu registered in the billing center. The authorization to use and the payment of a bill is performed through a financial agency which is connected to a billing center via a payment gateway. A billing plan can be selected from a time meter rate, a packet meter rate a hit rate. a session meter rate. a flat rate or a complex rate mixing a meter rate and a flat rate.

Preferred embodiments of the invention will be described hereinafter with reference to drawings.

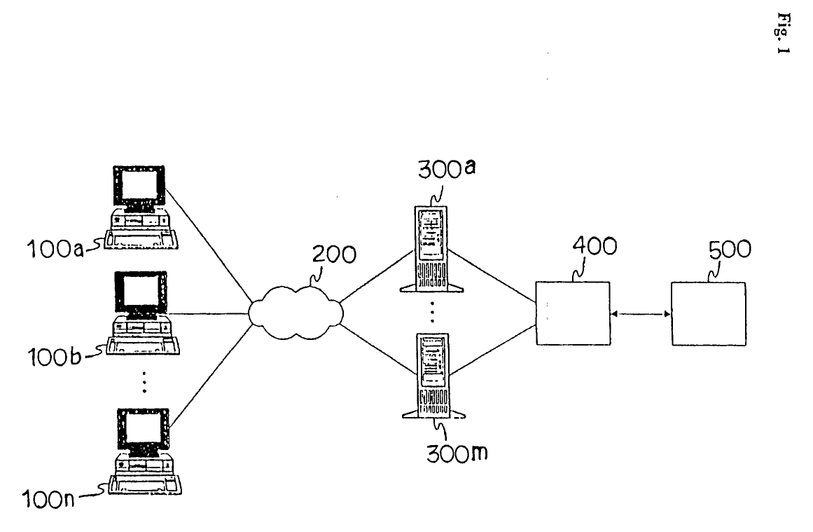

FIG. 1 is a schematic block diagram showing the construction of a billing system according to the present invention. In FIG. 1 the internet users (100a . . . 100n) are connected to diverse contents providers (300a . . . 300m) through the internet network (200) to get contents.

Details of information used by a client are monitored by a billing center (400) and are charged according to contents used.

The internet users select either an advance payment of a deferred payment in the internet contents billing center or the contents sites affiliated with the billing center. In case of an advance payment, an exchange ticket is purchased and is used for payment. There are two types of exchange tickets: one is used for specific site only and the other is used for all contents sites affiliated with the internet billing center.

In case of a deferred payment, client has to input his or her settlement information before use and the settlement information can be selected from a credit card number, a bank account number or a cell phone number.

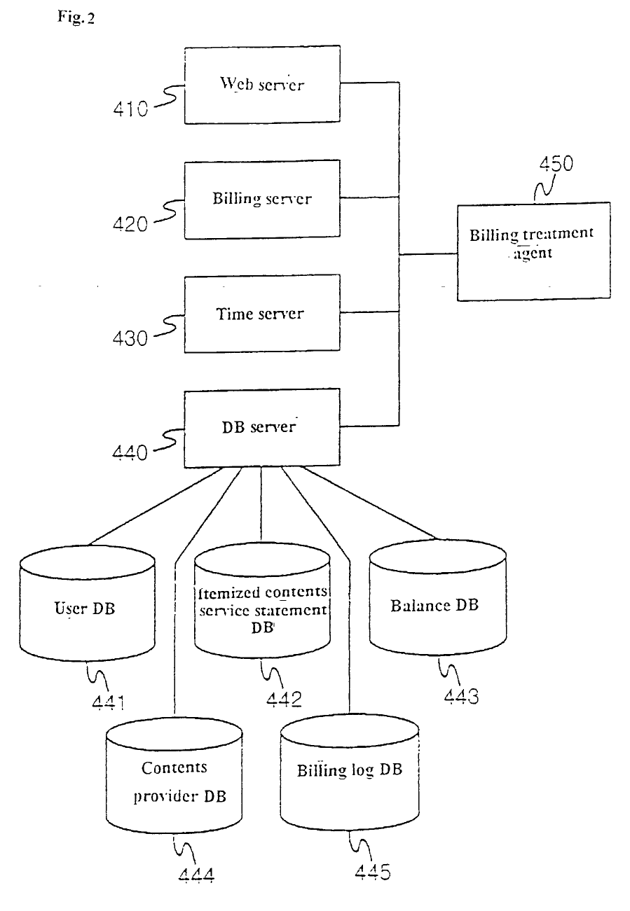

FIG. 2 is a schematic block diagram showing the internal structure of a billing center (400). FIG. 2 shows that the web server (410) enables the internet users or contents providers to connect the billing center (400) through a web. The billing server (420) performs such as menu information transmission, user authorization, inquiry the balance, and billing log creation, and allows the handling of request by billing clients (330) in a contents providers site. The time server (430) measures time in the time meter rate plan. The DB server (440) manages various databases in a billing center (400).

The databases in the billing center (400) include a user DB (441), a contents utilization itemized log statements DB which records detailed utilization history of users. a balance DB (443) which stores the balances of users, a contents provider DB (444) which stores information of contents providers and a billing log DB (445) which stores histories on billing.

The payment handling client (450) is connected to financial agencies through a payment gateway (500) and performs functions such as payment of expenses resulting from purchase of an exchange ticket or use of contents.

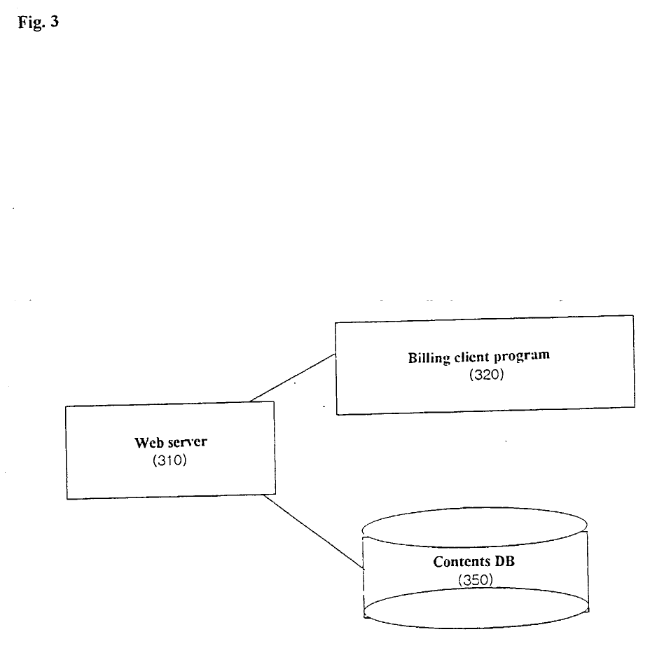

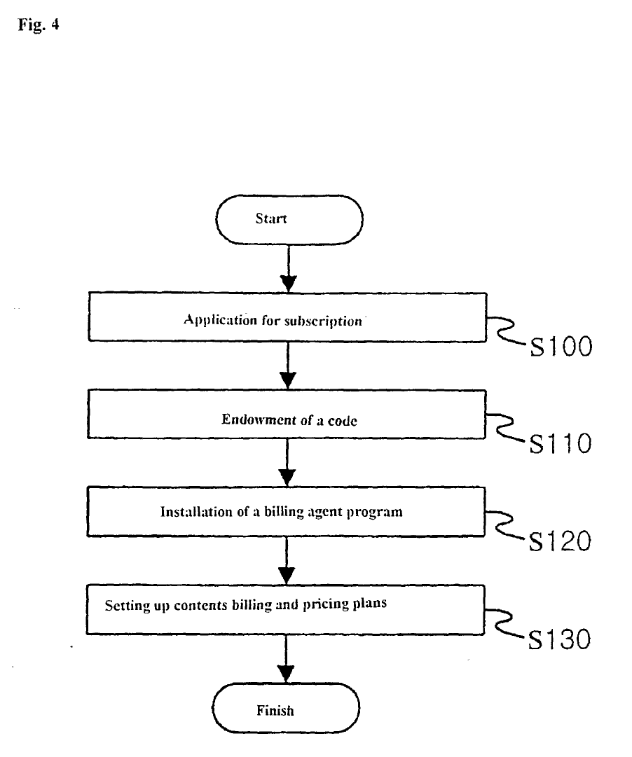

FIG. 3 is a schematic block diagram showing the internal structure of a contents provider (300). In FIG. 3 the web server (310) helps the internet users to connect the contents provider's site through a web. The billing client (330) is an HTTP service agent to relay the use of free/charged contents through wired or wireless connections. It carries out as proxy the billing resulting from the use of contents by communicating with a billing server (420) in a billing center (400). According to the request of a client, the billing client provides information requested by a client and transmits diverse information on billing to the billing server (420) after a user authorization and a balance identification steps.

Detailed procedures to use contents and to pay expenses by users are described below.

1. Registration of a User

Users trying to get information from a site adopting a billing system by a wired or wireless internet connections according to the present invention should register a billing center (400) first.

A user (100) connects to the homepage of a billing center (400) using a web browser installed in his or her computer. In the homepage, the user (100) moves to a ‘User Registration’ page, and inputs user information and decides an ID and a password. The user information comprises a resident registration number, an address. a telephone number, but it is not limited to the above information. The billing center (400) stores the information in a user DB (441).

Once the user registration is finished, a user (100) can purchase an exchange ticket. Also, the identification of user information such as remained balance or changes of user information are possible. When a deferred payment is selected, a user can access to contents after the user registration.

2. Registration of a Contents Provider

A contents provider (300) has to register a billing center (400) in order to utilize a billing plan according to the present invention.

A contents provider (300) connects to the homepage of the billing center (400) using a web browser. In the homepage, the contents provider (300) moves to a ‘Contents Provider's Registration’ page and fills out information to subscribe (S100 step). Once the request to join is approved, the billing center (400) issues a contents provider's code (“contents provider code” hereinafter) and recognizes it as a formal contents provider (S110 step). The provided information is stored in a contents provider DB (444).

The subscription of a contents provider is possible not only through an online but also in off-line. When the application form is filled out and is sent to a billing, center (400), the billing center may approve the subscription after an examination on the application form. The result is notified to a prospective contents provider via mail or an e-mail.

Once the contents provider finishes registration, it should install a client program for billing in the system providing contents (S120 step). The program is obtainable by downloading from a homepage or from a CD-ROM.

When the billing client program is downloaded, the contents provider code and the password obtained in the registration are entered and a billing client program corresponding to the contents provider code can be downloaded. When subscribing off-line, a billing agent program corresponding to a specific contents provider code is stored in a CD-ROM and is then delivered to a contents provider (300). Therefore, when the corresponding contents provider (300) installs a program by a CD-ROM, the billing client program corresponding to the contents provider code can be installed.

The contents provider installed a billing client program has to set a billing plan and a price for the contents provided (S 130 step).

Detailed methods for billing and pricing are described below.

2-1. Organization of a Directory and a Service File of a Contents Provider.

Before installing a billing client program. directories and service files of a contents provider needs to be organized systematically.

The unit of billing service provided in the present invention is a menu. A menu is a directory and a service file where contents of contents provider exists. That is, a contents provider (300) registers a menu in a billing center (400) according to directories and service files, and a billing client does a billing service on the contents of a contents provider (300) by the menu information registered in the billing center (400). Therefore, poorly organized directories or service files present problems in systematic billing on charged services.

a. Classification of Free/Charged Services

In first contents for free service and those for charged service are classified.

b. Establishment of Directories and Service Files to be Served by a Billing Client

It is possible to organize directories and service files so that both the free/charged services can be relayed by a client program, or only the charged service can be relayed by a client program.

The menu classified as a charged service can be either a real directory or a service file depending on a service type. which should be born in mind before organizing directories and service files.

The directory or service file registered on a service menu is used for a keyword in the link conversion process of a billing client program, therefore. registration of a directory or a service file in the same name is impossible.

c. Decision of a Billing Plan.

When a basic directory for a service is established, a billing plan has to be decided. In this invention, four billing plans such as a hit rate, a packet meter rate, a session meter rate, and a time meter rate plans are supported. A contents provider can select a billing plan suitable for the contents provided. The billing plan in the present invention also supports multiple billing plans and selection of all methods are possible.

d. Organization of a directory and a service file for real contents

The billing center provides a billing service in the unit of a menu, and a billing client provides contents containing information on the menu (which is a real directory or a service file containing contents of a contents provider and is an identical unit in classification items such as a billing plan/price/others). Therefore, the contents provider has to classify provided contents according to a menu for an appropriate billing. Also, the registered menu must have an 1:1 correspondence to either a directory or a service file. In other words, one directory or one service file must be registered on one menu. and once a directory or a service file is registered on a menu, it can not be registered on other menu. This is because a directory or a service file registered on a menu is used for a keyword in a link conversion process of a billing client program afterwards.

This concept must be understood before organizing directories and service files. The contents provider organizes service menus based directories and service files classified by desired billing plans.

e. Mapping of a Basic Service Directory by a Virtual Path.

Once the organization of a menu is completed, a basic service directory in a web server has to be mapped by a virtual path. At this time, only a basic service directory is mapped by a virtual path. and the name for a virtual path set to be identical with a real directory. For example, when a cbs directory is made as a basic service directory by defaults a virtual path is set to /cbs. Therefore, the virtual path is set to “http://domain address of a contents provider/cbs.”

f. Establishment of a Hyperlink, an Image and an Applet.

When a virtual path mapping for a basic service directory is completed. the paths for hyperlinks, images and applets of all documents have to be reset. All documents are linked so that they can be viewed properly and connected precisely. This procedure is to set the internal links of HTML documents to the changed directory paths.

Generally, the path for a link is either a relative link or an absolute link. The relative link is to set a path by ../../ based on the position of a document. and the absolute link is to set all paths from the root directory of a web server.

<Example of a Directory Organization>

The menu organization methods and procedures are explained below with examples. In the following exemplary site, in order to differentiate service menus by directories and for a proper service of a billing client, service menus are registered by directories which the real billing client program can identify.

a. Classify Free/Charged Services

Organization of contents of “MeetingNuri”

1. Explanation of a service

2. Applications (charged)

3. Information on female applicants (charged)

4. Information on male applicants (charged)

5. Board

Considering relations among the categories, items 1 to 4 including free services are provided through a billing client, and the board on the fifth item is provided through a free board offered from another site.

b. Basic Service Directory of a Billing Client.

“MeetingNuri” is decided to use CBS as a basic service directory. which is created under a root directory.

c. Decision of a Billing Plan

“MeetingNuri” is decided to employ both a hit rate and a packet meter rate plans. A basic billing plan is a hit rate plan and a packet meter rate plan is appled only in downloading a zip file containing information of female applicants or male applicants.

d. Organization of a Directory for a Menu Registration

| | | | | |
|---|---|---|---|---|
| C | CBS | free | image | |
| | | hit | bin | |
| | | | female | image |
| | | | | info |
| | | | html | image |
| | | | male | image |
| | | | | info |
| | | | register | |
| | | packet | bin | |
| | | | html | |
| | | | zip | |

In the above, directories actually registered on the billing center (400) are as follows.

C:\CBS\free: a directory containing a mother page connected to index.html and each contents service.

C:\CBS\hit\bin: a directory containing a program from a hit rate type contents.

C:\CBS\hit\female: a directory containing images and information on female applicants.

C:\CBS\hit\html: a directory containing a mother page having a hit rate type contents.

C:\CBS\hit\male: a directory containing images and information on male applicants.

C:\CBS\hit\register: a directory containing a page for a register.

C:\CBS\packet\zip: a directory containing zip files with information and images on female applicants or male applicants (a packet meter rate billing).

e. Mapping of a Basic Service Directory by a Virtual Path.

With the actual directories created above, virtual directories are mapped on a web server. The virtual directory path for mapping is the same with the actual directory path.

f. Establishment of a Hyperlink, an Image and an Applet.

The following is an exemplary homepage of MeetingNuri. Paths for hyperlinks, images and applets are established in a webpage as shown below.

. . .

<table border=0 cellpadding=3 align=“center”>

<tr>

<td><font size=4 color=“#FFFFFF”>1</font></td>

<td><a href=“/cbs/hit/female/image/chr_fpic1.jpg”>

<img src=“../female/image/fpic1.jpg” border=0 width=45 height=60>

</a></td>

<td><a href=“/cbs/hit/female/info/duo2.htm”>

<img src=“./image/text_profile.gif” border=0></a></td>

<td><img src=“./image/space.gif” border=0></td>

. . .

2-2 Billing and Pricing Plans

A contents provider (300) connects to a homepage of the billing center (400) and inputs an ID and a password to log in. The contents provider (300) moves to the “Contents Provider Service” page and sets and registers a billing plan and price.

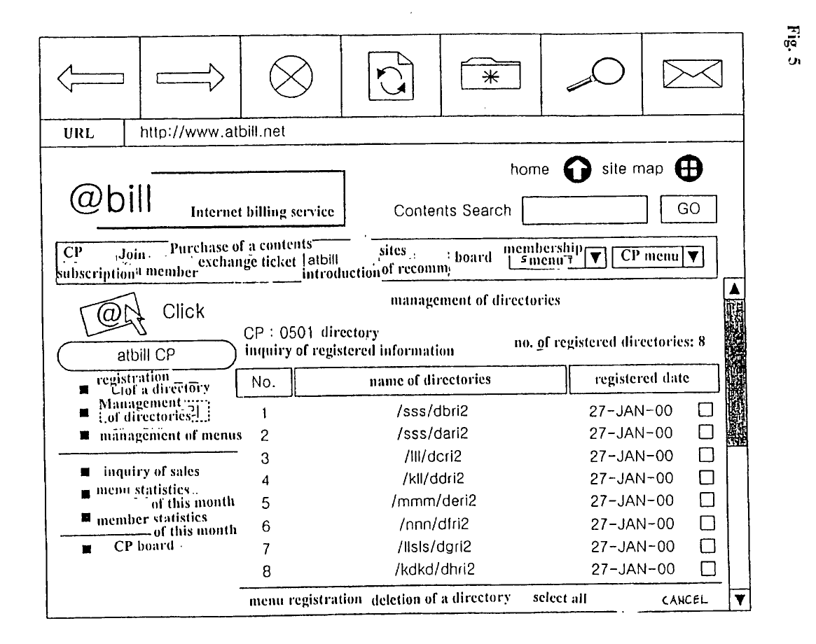

FIG. 5 to FIG. 8 are examples of the screens in this occasion.

FIG. 5 is an example of a screen when the contents provider (300) selects “Directory Management.” In this screen a list of directory registered by a contents provider appears. To register a new directory. select “Directory Registration” on the left menu.

In FIG. 5, directory can be corrected by clicking on a check box on the right side of directory list. Or. all directories can be selected by clicking on “Select All” on the bottom of the screen.

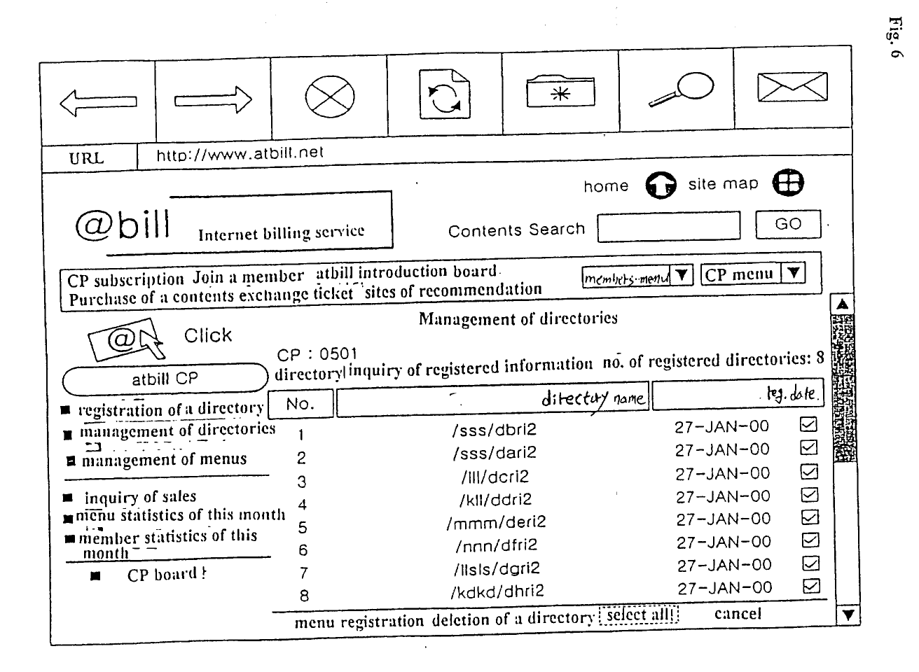

FIG. 6 is an example of a screen when all directories are selected by clicking on “Select All.”

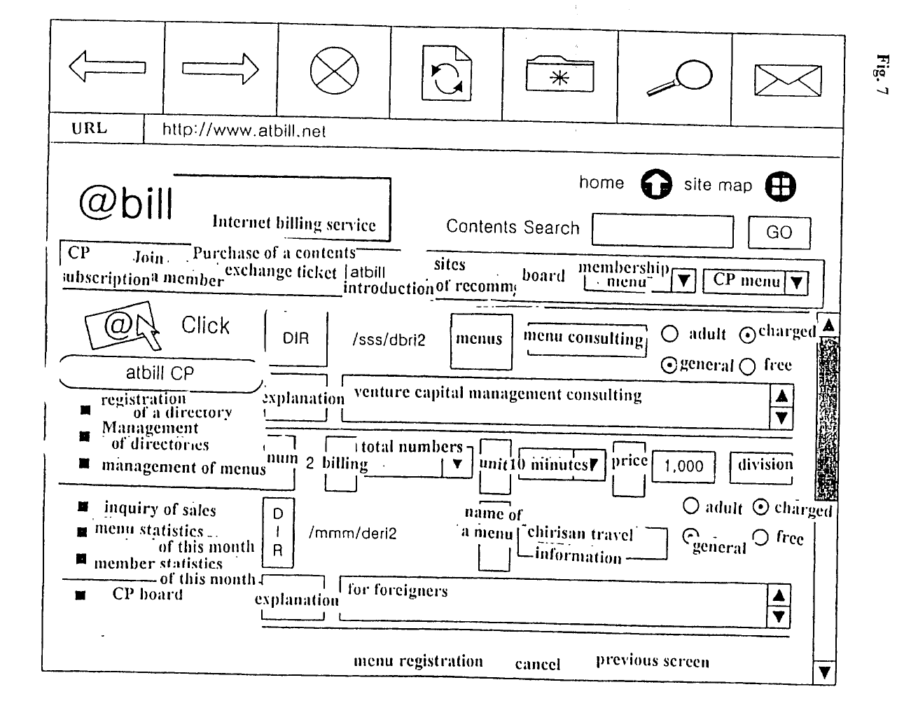

When a directory is selected the choice of “Menu Selection” on the left menu turns the screen as shown in FIG. 7. In FIG. 7 a contents provider (300) can decide a billing plan and price for the contents provided in its site.

That is to say, a billing plan is selected from “Billing” menu, a billing unit is selected from “Unit” menu, and a price for the billing unit can set in the “Price” menu. Furthermore, a contents provider (300) can assign a name of a menu in the corresponding directory.

In addition, it is possible to set contents for adult only or for general clients, or for charged service or for free. When contents is set for adults only, it is possible to identify if a client is adult or under age in a user authorization process and therefore it is possible to block an under age person from accessing the adult information.

When a billing plan and price are set, click on the “Menu Registration” button to finish the registration of a menu.

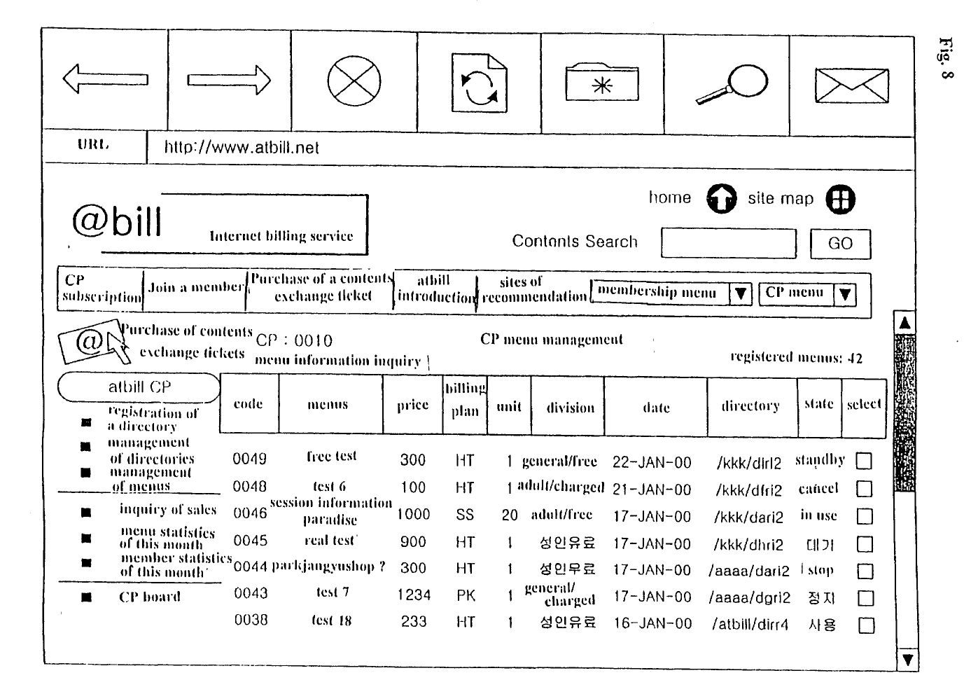

FIG. 8 is an example of a screen to manage the registered menu. FIG. 8 show a screen displaying a registered menu list.

FIG. 5 to FIG. 8 are just examples of setting a billing and pricing plans, The billing and pricing plans can be set under different user interfaces. The present invention is not limited to a specific user interface.

3. Purchase of an Exchange Ticket for Contents

Clients registered in the billing center (400) can purchase an exchange ticket for contents.

First of all, a client (100) connects to a homepage of a billing center (400) and inputs an ID and a password to log in. Next, the client moves to a purchase page for an exchange ticket for contents.

In the purchase page, a client selects a price and billing plan for an exchange ticket to purchase. The billing plans comprise a deposit without a passbook. a credit card, an automatic transfer, an electronic money which can be used in the internet but are not limited to those methods.

Once a client (100) selects a billing plan. the selected plan is transmitted to a billing gateway (500) and appears on a billing gateway window. The client inputs information on payment such as a credit card or a bank account number on the billing gateway window. Then, the billing gateway (500) confirms client's information from a credit card company or a bank and transmits the result to the windows of a client's browser.

The results from the billing gateway are transmitted to a billing center (400). The billing center (400) supplements the client's purchase statement to its database when the billing gateway approves the client's request, and renews the client's balance DB (443). The renewed balance DB of a client is transmitted to a client's browser.

4. Use of Contents and Billing

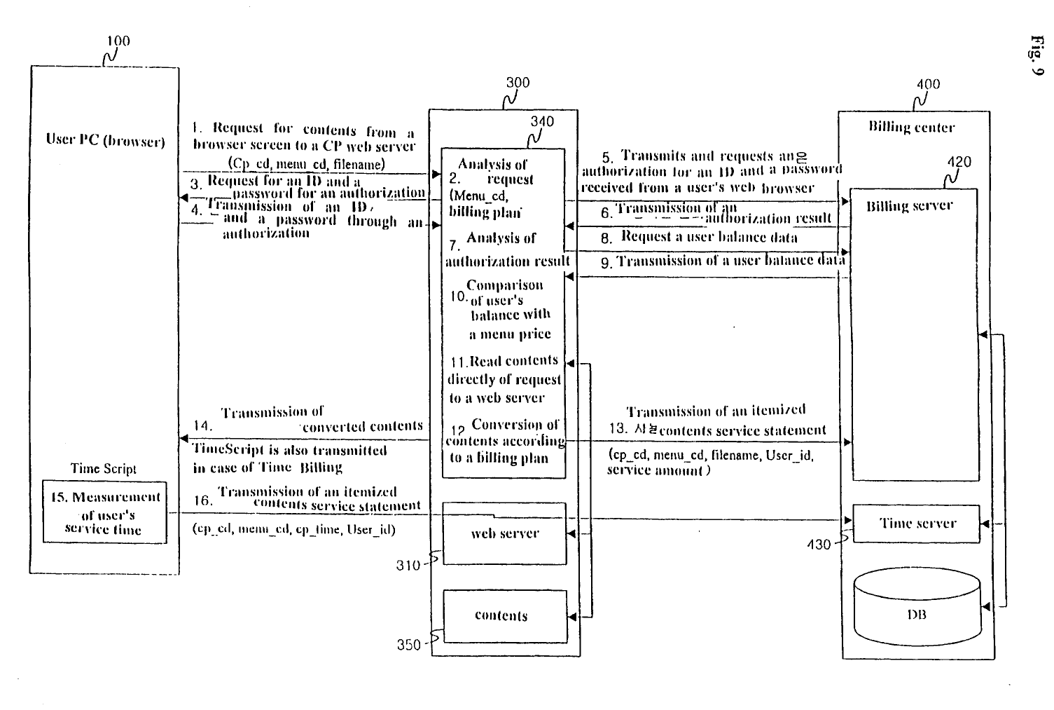

The process of billing in the use of contents by a client (100) is explained with FIG. 9.

1. Request for Contents via a Contents Provider's Web Server in a Browser Screen (Cp_cd. Menu_cd. Filename)

Request a pertinent contents to the billing client (330) in a browser screen.

The procedure comprises inputting a pertinent URL in the upper part of a browser. or click on a link of a page.

Upon request the information transmitted to a billing client of contents provider is cp_cd, menu_cd and filename of the corresponding contents.

2. The Billing Client (330) of Contents Provider Analyzes Requests from a Client's Browser

From the menu_cd transmitted upon request, the menu information is analyzed by a hash table of the billing client (330).

It analyzes free/charged services, billing plan, price, states, etc. of the requested menu.

In case of a charged service. it requests an authorization of a client by opening an authorization window, and in case of free services proceeds step 11 without authorization.

In case of a session meter rate plan from the analysis of billing plan, it needs to analyze if it is an ongoing session or a new session.

The continuance of a session is decided from the header information of the request transmitted from a browser.

In case of an ongoing session, proceeds to step 11 without transmission of authorization, balance checking and an itemized log statement.

3. Request for an ID and a Password for an Authorization (Charged Menu)

In case of a charged service, request an ID and a password to a client's browser for a client authorization.

The request for an ID and a password is performed by the request of an authorization header defined in the HTTP protocol.

4. Transmission of an ID and a Password Through an Authorization Window (Charged Menu)

The client's browser opens an authorization window to input an ID and a password upon the authorization request of a billing client (330) of a contents provider (300).

A client inputs an ID and a password in an authorization window and a browser transmits the information to the billing client (330).

5. Transmission of an ID, a Password cp_cd Received from a Client's Browser and Request for Authorization (Charged Menu)

The ID, password and cp_cd received from a client's browser are transmitted to the billing server (420) and are requested for an authorization.

6. Transmission of Authorization Results (Charged Menu)

A billing server (420) identifies an ID and a password of a client through an examination of the client's information from a client DB (441), and determines if the client is a registered user in the billing center (400).

After identifying the client the authorization result is transmitted to the billing client (330).

7. Analysis of Authorization Results (Charged Menu)

By analyzing the authorization result received from a billing server (420), registration state of a client is confirmed.

If it is found that the client is not registered, a request for an ID and a password is sent to a client's browser again.

8. Request for a Balance Data of a Client (Charged Menu)

After identifying client's registration, a request for a balance is sent to a billing server (420).

Upon balance request, client's ID and password are also transmitted.

9. Transmission of a Client's Balance Data (Charged Menu)

The billing server transmits a client's balance data to the billing client (330) after examining the client's balance data from a DB of the billing server (420).

10. Comparison of the Client's Balance and the Price of a Menu (Charged Menu)

The billing client compares the price of a corresponding menu with the client's balance after receiving the balance data from the billing server (420).

If the balance is less than the price of the corresponding menu, transmits an inadequate balance message to a client's browser and stop the requested service.

If the balance is more than the price of the corresponding menu, proceed to step 11.

11. Provide Contents Directly or by Requesting to a Web Server

Analyze the position and types of the corresponding contents file through a requested menu and the file name after examining a hash table of the billing client (330).

If the corresponding contents is an HTML or a binary file (files other than a HTML document or web programs (CGI, PHP, etc.)), the billing client (330) provides the file directly from a contents provider's server.

If the corresponding contents file is a web program, the billing client (330) requests the contents to a contents provider's web server through a HTTP protocol.

12. Conversion of Contents According to a Billing Plan

The results obtained by reading or requesting through a web server are converted.

Through the conversion process. the link of HTML document prepared by a contents provider is converted to a link form which can pass the billing client (330).

The information for the conversion is brought from a hash table of the billing client (330).

If the menu is under a time meter rate plan, a time script which can measure time to use the converted contents file is included.

13. Transmission of an Itemized Log Statement of a Client (Charged Menu)

In case of a charged menu. an itemized log statement of a client on the contents provider's contents is transmitted to a billing server (420).

The information transmitted comprises cp_cd, menu_cd, filename, user_id. balance and a service amount.

The service amount is 1 in case of a hit, session and time meter rate plan and it depends on the size of contents in case of a packet meter rate plan.

The balance taken out the menu price (the menu price depends on a service amount in case of a packet meter rate plan) is transmitted.

14. Transmission of Converted Contents (Transmission Including a Time Script in Case of a Time Meter Rate Plan)

The billing client (330) transmits converted contents of a contents provider to a client's browser.

In case of a time meter rate plan, contents with a time script are transmitted.

When a time script is included, variables used for the tine script are converted before transmission.

15. Measurement of Service Time of a Client (in Case of a Time Meter Rate Plan)

The time script transmitted from the billing client to a client's browser checks time from the moment the pertinent contents page is loaded on a client's browser screen.

The time served on a client's browser is compared to the time set on interval variables of a time script and is checked if it passed the set time or not.

After a time set on an interval variable the time script repeatedly transmits a log statement information to a time server (430).

16. Transmission of Client's Itemized Log Statement (in Case of a Time Rate Plan)

In the time meter rate plan the time script transmits a client's itemized log statement to a time server at intervals specified on the interval variables.

The client's itemized log statement comprises cp_cd, menu_cd, user_id, and a password. and the time the corresponding menu service begins is also transmitted.

The time server which received the client's itemized log statement sent by the time server updates a service provided in the client's itemized log statement by setting the time menu service begins as an identifier.

5. The Operation of the Billing Client According to a Billing Plan

Detailed explanations on the operation of a billing client according to a billing plan is presented hereinafter.

5.1 A Hit Rate Plan and a Packet Meter Rate Plan.

A hit rate plan is a billing plan which charges every time a client browses information by clicking on a designated page. A packet meter rate plan charges in a similar way. However in the packet meter rate plan, the price of each menu is decided by the size of a contents file.

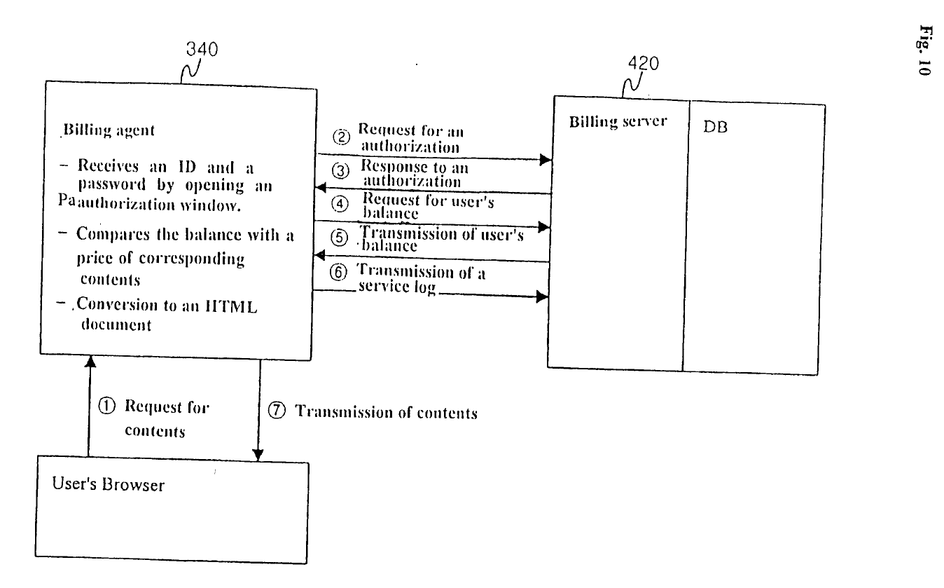

FIG. 10 is a drawing showing the motion flow of a billing client in a hit rate and a packet meter rate plan

In first, a client request contents of a contents provider's menu to a billing client (330) using a browser (\mathring{1}). Then, the billing client (330) opens an authorization window to receive a client's ID and a password and transmits them to a billing server (420) (\mathring{2})

The billing server (420) identifies the transmitted ID and the password and transmits the results to a billing client (330) (\mathring{3}).

If an authorization is failed, the billing client (330) tries authorization again. If authorized, it requests a balance for a client's contents exchange ticket to a billing server (420) (\mathring{4}).

The billing server (420) transmits client's balance to the billing client (330) (\mathring{5}). The billing client (330) receives the client's balance, and if the balance is less than the price of the corresponding contents menu it transmits an insufficient balance message. In a hit rate plan, the price of a corresponding menu is the price of a contents. In a packet meter rate plan, the price of a contents is decided by the file size.

According to the use of contents by a client, client's log statement on the content is transmitted to the billing server (420) (\mathring{6}).

If the balance is more than the price of the contents menu, real contents is transmitted to a client's browser (\mathring{7}). In this occasion, if the contents is an HTML file a conversion process on the links is performed.

For client's passed the authorization step, the steps \mathring{1}-\mathring{3} are omitted and the steps from \mathring{4} are repeated.

5.2 A Session Meter Rate Plan

A session meter rate plan is a plan which charges a client for a session participated.

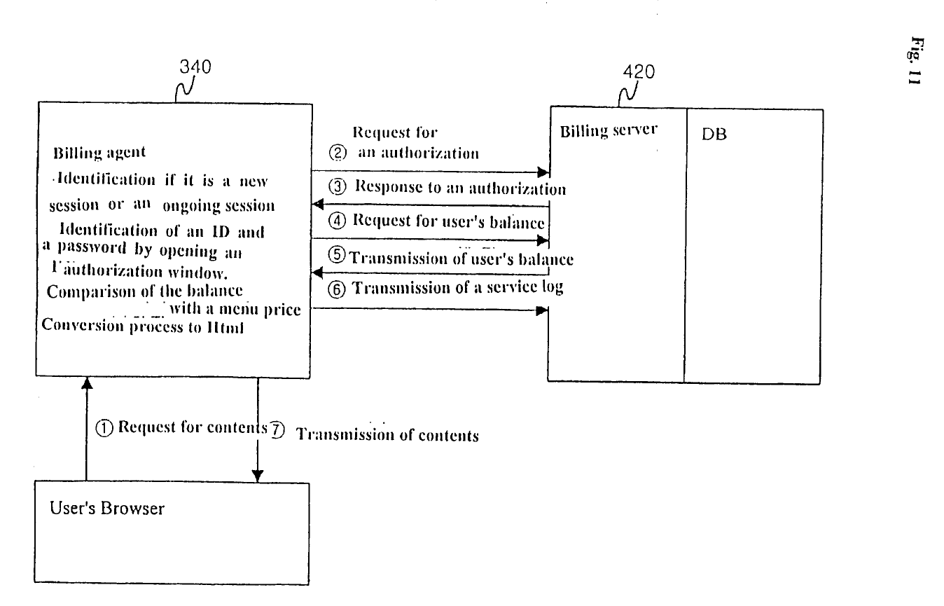

FIG. 11 is a drawing showing the motion flow of a billing client in a session meter rate.

A client requests contents of a contents provider's menu to the billing client (330) using a web browser (\mathring{1}).

Then, the billing client (330) determines if the current session is an ongoing session or a newly begin one. If it is an ongoing session, it transmits real contents to a client's browser without an authorization nor a request for a balance (\mathring{7}).

For a newly begin session, current time is saved in the session information and an ID and a password received from an authorization window are transmitted to a billing server (420) (\mathring{2}). The billing server (420) transmits the results to a billing client (330) after an authorization step (\mathring{3}).

If an authorization is failed, the billing client opens an authorization window continuously for an authorization. If authorized, the billing client (330) requests a client's balance to a billing server (420) (\mathring{4}), and the billing server (420) transmits the client's balance to the billing client (330) (\mathring{5}).

The billing client (330) confirms the client's balance and compares it with the price of a corresponding menu. If the balance is insufficient, it transmits the insufficient balance message to a client's browser. If the balance is sufficient, the requested contents is transmitted to the client's browser (\mathring{7}).

When the billing client (330) transmits contents to a client's browser, if the contents is an HTML file. conversion process on the links is performed prior to transmission.

For client's passed the authorization steps, the steps (\mathring{1})-(\mathring{3}) are omitted and the steps from (\mathring{4}) are repeated.

Determination if it is a new session or an ongoing session:

If the header received from a client's browser does not contain a session information on the corresponding menu, the session is considered as a new session.

When the header received from the client's browser contains a session information on the corresponding menu, the time stored in the session information is compared with the time the current billing client operates (330). If it is longer than the time set in the session information. the session is considered as a new session.

If the header received from the client's browser contains a session information on the corresponding menu and none of the above cases applies it is considered as an ongoing session.

5-3 A Time Meter Rate Plan

A time meter rate plan is a plan which charges by the time a client uses contents. In the time meter rate plan a specified amount is charged on a specified interval such as 100 won per minute.

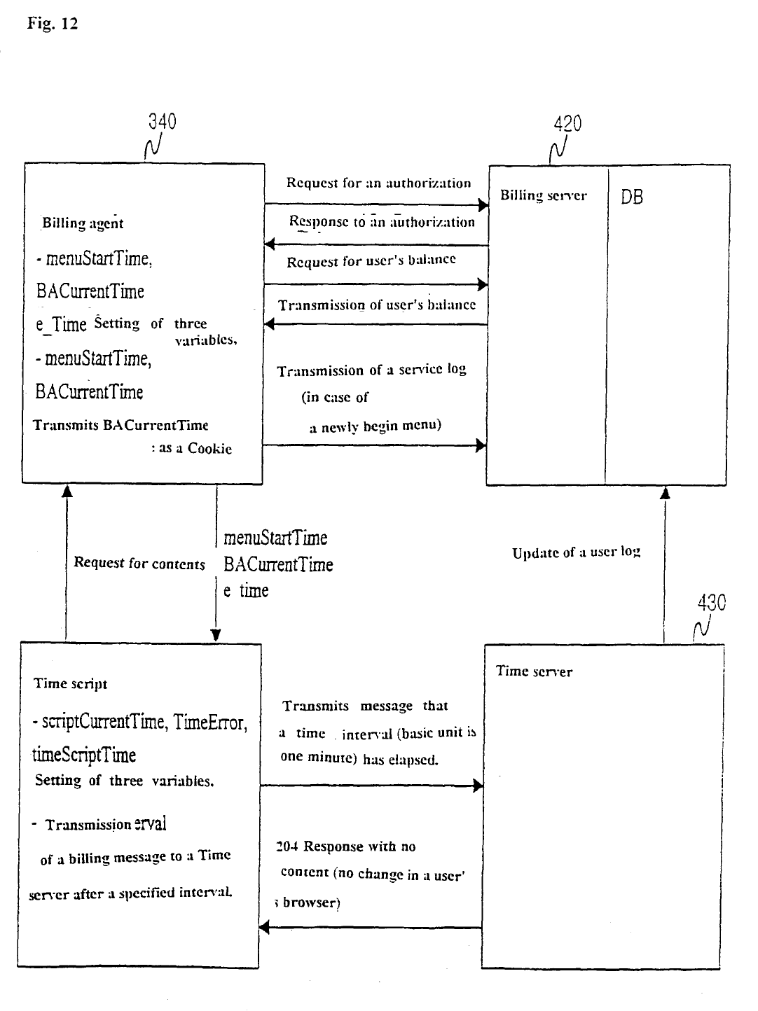

FIG. 12 is a drawing showing the motion flow of a billing client in a time meter rate plan.

<Legends on variables>

menuStartTime: The time when a menu started (cp_time)

BACurrentTime: The time when the billing client operates

scriptCurrentTime: The time when a time script operates

timeError: Difference between BACurrentTime and scriptCurrentTime

A variable to synchronize the billing client and TimeScript

timeScriptTime: The time set on a Cookie which is transmitted from the TimeScript to a browser

e_time: The time when the first menu started or the elapsed time since a message is sent to the TimeServer.

interval: Unit time for billing

timeMenuContinue: The flag to identify if a menu is ongoing or not.

<Operation in the billing client>

It reads menuStartTime and BACurrentTime from Cookies transmitted from a browser.

Stores current time in tile BACurrentTime.

Set the timeMenuContiune flag by determining if the menu newly begins.

In case of a newly begin menu, the BACurrentTime is stored in the menuStartTime.

In case of an ongoing menu, the menuStartTime received from Cookie is used as it is.

The BACurrentTime and menuStartTime are turned into Cookies and saved in the response object (using res.addCookie function).

In case of a newly begin menu, it is logged in after requests for a user authorization and a balance. In case of an ongoing menu. requests for a user authorization and a balance are performed without a logging in transmission.

Creates a time script and sets variables used in the time script.

e_time=(BACurrentTime−menuStartTime)%interval

Transfers the BACurrentTime and the menuStartTime

<Operation in the Time Script>

Stores current time in the scriptCurrentTime.

To synchronize with the billing client (330), the BACurrentTime and the scriptCurrentTime are saved in the timeError.

Once the time script has begun and the interval-e_time has passed, it transfers a message to the time server. Since then, it transfers messages to the time server every interval period.

When the message is transferred, the timeScriptCookie is set and is sent to a browser (this Cookie is received by a billing client (330) at a later time).

The time when a message is transmitted (timeScriptTime) is stored in the timeScriptCookie. That is, the timeScriptTime equals startMenuTime+interval*n (at this point, in order to save the current time to the billing client (330), the scriptCurrentTime+timeError is saved).

<Setting of TimeMenuContinue Flag>

To identify if a menu is under an ongoing state or newly begins, timeMenuContinue flag is created.

Imagine two menus, menu A and menu B. A → B is moving to a new menu and A → A means an ongoing menu. Within an interval (one minute), if a client moves like A → B→ A, then A → B is beginning a new menu and B → A is an ongoing use of a previous menu A.

Flag Setting

If (BACurrentTime−timeScriptTime)<(60+error), then menu is considered ongoing.

Error is introduced because of a dead time involved in the request step to the billing client (330) or a dead time in the movement of Javascript.

<Cookie>

In the time billing there are three Cookies transmitted from a client's browser:

startMenuTime, BACurrentTime, timeScriptTime

All three Cookies have cp_cd, menu_cd in the end, and can be controlled according to contents provider or a menu.

If cp_cd is 050! and menu_cd is 0010, the following three Cookies are transmitted;

startMenuTime05010010, BACurrentTime05010010. timeScriptTime05010010

Regarding a billing statement, the billed amount is subtracted from the client's balance DB in an advance payment. In a deferred payment, a billed amount for a specified period (one month for example) is withdrawn from a client's account by means of credit card or automatic transfer, etc.

Above examples illustrate this invention in detail. However, these examples are only for illustrating the present invention, and the present invention is not limited to these to these examples.

### INDUSTRIAL APPLICABILITY

As explained above according to the present invention. it is not necessary to construct an additional system for billing and payment by a wired or wireless contents provider because a billing center handles billing and payment involved in the use of information through the internet collectively.

Furthermore, the billing plan involved in the use of information through the internet can be selected from a time meter rate, a packet meter rate, a hit rate, a session meter rate, a flat rate or a complex rate mixing a meter rate and a flat rate, and therefore an effective billing suitable for the characteristics of each site can be chosen.

Still furthermore, the billing unit is a menu and each menu corresponds to one directory, which makes the correction, addition or deletion of contents by a contents provider easy. It is because the contents is composed of a single file unit and the position of the contents in a directory affects billing. In order to add contents simply place contents in a directory registered as a menu and no other additional correction is necessary.

1. An internet billing system which is to bill service charge resulting from the use of contents in a contents provider's website by an internet user, and comprises a billing center, a wired and wireless contents provider, a billing gateway for an interface of the billing center and a financial agency;
wherein the contents provider comprises
a web server for an internet user to use contents by connecting to a contents provider through the internet, and
a billing client providing a service according to a request of a client and transmitting diverse information on billing to a billing server after completing a user authorization and a balance identification by the request of a user through a connection to a billing center,
the billing center comprises
a web server to connect to the above billing center for an internet user or a wired or wireless contents provider,
a billing server which handles the request of a billing client (330) which transmits menu information. authorizes a user, examines balance. creates billing log to serve in the contents provider's site,
a DB server which manages a user DB storing information on users, a contents log statement DB recording a client's log statement on contents, a balance DB storing balance of users, a contents provider's DB storing information on a contents provider and a billing log DB storing history on billing. and
a billing treatment client which performs paying expenses resulting from use of contents by a user in connection to a financial agency through the aforementioned billing gateway.

2. An Internet billing system according to the claim 1,
wherein the aforementioned billing center contains an additional time server to measure time, and the time server measures the internet user's served time on the contents assigned to a time meter rate plan and notifies the service time to a billing server.

3. An internet billing plan which is to bill service charges resulting from the use of contents in a contents provider's website by an internet user by employing a billing system which comprise a billing center, a contents provider connected to the billing center, a billing gateway for an interface of the billing center and a financial agency,
which is characterized by
an internet user registration step in which an internet user registers in the above billing center,
a contents provider registration step in which the above contents provider registers in the above billing center and installs a billing client program,
a contents use request step in which the above internet user requests the use of contents provided by the above contents provider,
a contents offering step in which the above billing client program requests contents asked by the above internet user to the above billing server of the billing center followed by the offering of the contents authorized by the above billing server to the internet users, and
a billing step in which the above billing client bills users according to an itemized served contents statement.

4. An internet billing plan according to the claim 1,
wherein the above contents provider registration step comprises
a step in which the above contents provider register while providing information about itself,
a step in which the above billing center stores contents provider's information to a database endows with a code and the client program endowed with a code is provided to the contents provider.
a step in which the above contents provider installs the above client program, and
a menu registration step in which the above contents provider registers a directory or a service file classified by a billing plan to the billing center.

5. An internet billing plan according to the claim 1,
wherein in a packet meter rate plan the contents is provided to an internet user if the price assigned to the size of contents requested by an internet user is less than the user's balance.

6. An internet billing plan according to the claim 1,
wherein in a session meter rate plan the contents is provided to an internet user if the price assigned to a session is less than the user's balance in case of a newly begin session.

7. An internet billing plan according to the claim 1,
wherein in a time meter rate plan the contents is provided to an internet user if the price assigned to a predetermined interval since the beginning of a specific menu by the internet user is less than the user's balance.

8. An Internet billing plan according to any claim from the claim 3 to claim 7,
which additionally comprises a step in which the above internet user purchase a contents exchange ticket by connecting to the above billing center,
a step in which the above billing center renews the user's balance database according to the contents exchange ticket amount purchased by the above internet user and
a step in which the amount resulting from the use contents by the internet user is subtracted from the balance of the balance database.
